(19) United States
(12) Patent Application Publication
(10) Pub. No.: US 2015/0211494 A1
(43) Pub. Date: Jul. 30, 2015

(54) ANGULAR POSITIONING SYSTEM FOR A WIND TURBINE

(71) Applicant: ALSTOM RENEWABLE TECHNOLOGIES, GRENOBLE (FR)

(72) Inventor: Jaume Betran Palomas, Sant Cugat Del Valles (ES)

(73) Assignee: Alstom Renewable Technologies, Grenoble (FR)

(21) Appl. No.: 14/420,967

(22) PCT Filed: Aug. 26, 2013
(86) PCT No.: PCT/EP2013/067618

§ 371 Date: Feb. 11, 2015

Related U.S. Application Data
(60) Provisional application No. 61/719,864, filed on Oct. 29, 2012.

(30) Foreign Application Priority Data
Aug. 27, 2012 (EP) 12382332.0

(51) Int. Cl. F03D 11/00; F03D 7/02

(52) U.S. Cl. CPC F03D 11/00; F03D 7/0204; F03D 7/0224

(57) ABSTRACT

It comprises first and second rotatable elements and driving device for driving them in rotation comprising hydraulic chambers which volume is defined by the relative position of the elements in the plane of rotation and pumps for filling the chambers with fluid to cause their expansion for rotating the elements, and a pump controller for controlling rotation of the elements. The volume of chambers is defined by portions of the first element (200) and portions of the second element, or by space between portions of the first element with a portion of the second element (300) being movably provided inside chambers defining variable volume sub-chambers.

An angular positioning system for a wind turbine is herein disclosed. The present angular positioning system is intended to be used in a wind turbine pitch blade mechanism. However, the present angular positioning system is not limited to such particular application and can be used in many others, such as for example a wind turbine nacelle yaw mechanism.

The present angular positioning system mainly comprises first and second mutually rotatable elements and a driving device for driving said first and second mutually rotatable elements in rotation. The driving device of the angular positioning system comprises one or more hydraulic chambers that are defined by at least a first portion of the first element and a second portion of the second element.

A wind turbine comprising such angular positioning system is also herein disclosed. The angular positioning system in said wind turbine serves the purpose of driving in rotation the first and the second mutually rotatable elements of the wind turbine.

### BACKGROUND

Known wind turbines are provided with angular positioning systems such as the blade pitch mechanism.

The rotor of a wind turbine comprises a hub and a number of blades that are mounted on the hub. Although the blades can be directly bolted to the hub and then stalled thereto, the blades are usually attached to the hub through the pitch mechanism.

The pitch mechanism serves the purpose of adjusting the angle of attack of the blades according to the wind speed in order to control the hub rotational speed. This is carried out by rotating each blade around its longitudinal axis, that is, the axis extending from the blade root to the blade tip.

The rotational orientation of the blades for adjusting their angle of attack allows the load on the blades to be controlled. By controlling the blade pitch angle at any given the hub rotational speed can be suitably controlled according to specific power production requirements.

Adjusting the angle of attack of the blades also serves the purpose of performing a rotor braking function. This is achieved by moving the blades through the wind turbine pitch mechanism into a blade feather position. This position allows the blades from being protected from damages and wear which could lead to malfunction.

Known wind turbine pitch mechanisms typically comprise a pitch bearing. The pitch bearing is arranged between the rotor hub and the rotor blade for ensuring proper rotation of the rotor blade relative to the hub as stated above.

The pitch bearing generally comprises a number of rows, such as two or three, of rolling elements, usually balls. The rolling elements transfer the torque from the blades to the hub and withstand the operating working loads. The pitch bearing further comprises a number of bearing races, such as two: an outer, larger race bearing, and an inner, smaller bearing race. The rolling elements of the pitch bearing are provided between said bearing races.

In a pitch bearing of a common wind turbine pitch mechanism, one of the pitch bearing races, e.g. the outer bearing race, is connected to the hub, while the other pitch bearing race, e.g. the inner bearing race, is connected to a blade root portion (or sometimes to an extender).

Standard pitch mechanisms further comprise a pitch drive. Common pitch drives comprise a motor such as an electric servomotor, a drive pinion, and an annular gear meshing with the pinion. The annular gear is attached to the inner bearing race of the pitch bearing. Rotation of the inner bearing race causes rotation of the outer bearing race of the pitch bearing and thus rotation of the rotor blade attached thereto. This causes the blade pitch angle to be varied. The pitch drive therefore actively rotates the blades along their longitudinal axes for their accurate angular positioning in order to adjust the angle of attack as stated above. One example of this mechanism is disclosed in document US2012114487.

Other driving means may comprise, for example, hydraulically actuators causing each rotor blade to rotate to the desired pitch angle. One example is disclosed in document EP2458203.

As it is known, the angular displacement in blade pitching is small. The pitch mechanism of a wind turbine allows the blade to be rotated around its longitudinal axis from 0° to 90°. When the wind turbine is operating in normal conditions the blade pitch angle may range from about 0° to about 25° depending on the wind speed and therefore the power. When the wind speed is above 25-30 m/s the blade pitch angle may be 90° in order to stop the wind turbine rotor to protect the assembly. Therefore, not all of the rolling elements in common wind turbine pitch mechanisms are fully used.

When rotor blades are rotated through known pitch mechanisms high radial forces are generated. This results in high wear on the teeth of the drive pinion and the annular gear of the pitch mechanism. Loads are concentrated on specific areas of the bearing races which may lead to failure.

In addition, wind turbines are becoming increasingly larger and consequently blades are becoming increasingly heavier. Bearings base their behaviour on very small contact regions, namely those of the rolling elements with the bearing races. Bigger bearings will be slenderer and therefore bigger deformations will be generated. This can undesirably compromise good load transmissions between rolling elements and bearing races.

There is therefore a need for an angular positioning system that can be used, for example, in a pitch blade mechanism, and/or other rotating parts in wind turbine applications, which can at least mitigate the above disclosed disadvantages.

### SUMMARY

An angular positioning system for a wind turbine is disclosed. The system comprises first and second mutually rotatable elements and a driving device for driving at least one of the elements in rotation, the driving device comprising at least one hydraulic chamber, wherein the volume of the hydraulic chamber is defined by a relative position of the first and second elements in a plane of rotation; the driving device further comprising a pump for filling the hydraulic chamber with fluid in order to cause an expansion of the chamber such that the first and the second elements are rotated relative to each other, and a controller for controlling the pump, thereby controlling the rotation of the first and second elements.

A wind turbine comprising said angular positioning system is also disclosed. The angular positioning system in the present wind turbine is suitable for driving at least one of two mutually rotatable elements in rotation. Advantageous embodiments are defined in the dependent claims.

The present angular positioning system comprises first and second mutually rotatable elements. In the specific embodiment in which the angular positioning system is applied to the pitch blade mechanism in a wind turbine, the first and second mutually rotatable elements correspond to the blade and the hub of the wind turbine rotor, respectively.

The angular positioning system further comprises a driving device for driving at least one of said elements in rotation. The driving device comprises at least one hydraulic chamber. The volume of the hydraulic chamber is defined by the relative position of the first and second elements in the plane of rotation. The plane of rotation here is a plane arranged substantially at a right angle to the axis of rotation of both elements. Therefore, depending on the relative angular rotation of the first and second elements and hence the angular distance between the first and second portions, the hydraulic chamber or hydraulic chambers will have a greater or smaller volume. As a consequence of such arrangement, expansion of at least one of the hydraulic chambers causes the elements to be rotated to each other.

In one specific embodiment of the present angular positioning system, the volume of hydraulic chamber is defined by at least a first portion of the first element and a second portion of the second element. The portions of the first element and the second element may be a protrusion thereof extending in opposite directions to each other, respectively

In an alternative embodiment of the present angular positioning system, the hydraulic chamber can be defined by the space between at least two mutually spaced apart portions of one of the first and second elements. The mutually spaced apart portions are also in this case protrusions radially extending from the element in question. In this embodiment, a respective protruding portion of the other of the first and second elements is allowed to slide inside the hydraulic chamber thus defining corresponding variable volume sub-chambers.

The driving device of the present angular positioning system further comprises a pump for injecting hydraulic fluid such as oil into the hydraulic chamber for causing the expansion of the hydraulic chamber as stated above. The pump is part of a hydraulic closed circuit.

The driving device of the present angular positioning system further comprises a controller. The controller is suitable for controlling the pump and therefore for accurately controlling rotation of the first and second mutually rotatable elements.

In a blade pitch mechanism, control of time and pressure of fluid injected into the hydraulic chambers allows the blade to be accurately rotated for a precise angle of attack according to the wind speed and thus for efficiently controlling the rotational speed of the hub of the wind turbine according to the conditions and the power requirements. The expansion of the hydraulic chamber causes the blade to be pitched in a controlled manner with no wear of inner parts such gear teeth.

In embodiments in which a number of hydraulic chambers are provided, the pump is arranged connecting two adjacent hydraulic chambers to each other such that fluid is pumped from one hydraulic chamber to another hydraulic chamber. The hydraulic chambers can be grouped in sets of hydraulic chambers. More specifically, the driving device may comprise a number of sets of chambers covering different angles of the first and second elements. Each set of chambers may have a pump associated therewith.

All of chambers are capable of covering an angle ranging from 0 to 90 degrees. In some embodiments it is preferred that at least one chamber of the sets of chambers may cover an angle ranging from 0 to 24 degrees. These values refer to the angular extension on the perimeter of the first element or the second element. The first and the second elements are typically circular in cross-section.

The present angular positioning system may further include at least one bearing arrangement. The bearing arrangement may be of the conventional type, that is, comprising a number of rolling elements arranged in two or more rows. The rolling elements may comprise at least one series of balls suitable for supporting high loads and reducing friction and at least two bearing races: an outer bearing race connected to the rotor hub and an inner race connected either to a blade root portion or to an extender.

In other, preferred embodiments, the present angular positioning system alternatively comprises at least one bearing arrangement comprising a hydraulic mechanism instead of the above mentioned rolling elements. The hydraulic mechanism includes at least one hydraulic chamber. The hydraulic chamber or hydraulic chambers are formed between the first and the second elements.

A number of fluid injectors are also provided. The injectors are adapted for injecting fluid into the chambers. A controller is further provided for separately controlling the pressure of the fluid injected by the injectors. The pressure of the fluid supplied by the injectors is thus controlled separately and their values can be varied depending on at least loads on the first or the second element. The control of the pressure supplied by the injectors allows the radial distance between the first and second mutually rotatable elements to be accurately varied. In a practical case, this is performed by injecting more or less quantity of oil into a particular hydraulic chamber. Concentration of radial loads can be highly reduced by the provision of a number of injectors working simultaneously and controlled separately.

The provision of a number of injectors distributed around the length of the first and second elements is highly advantageous. The relative movement between the blade and the hub in a pitch bearing is very small, such as of the order of several degrees. This small relative movement occurs from a given wind speed value. When this relative movement takes place, the relative angular speed is very slow, of the order of 5 degrees per second. The provision of a number of injectors working simultaneously and controlled separately has the advantage that the film of hydraulic fluid between the blade and the hub is continuous. This also allows compensating for the action of the gravity in the blade changing angular position. By providing several injectors for injecting fluid into the chambers the bearing races are prevented from being contacted to each other when in use.

The separate control of the injectors advantageously allows different values of pressure to be supplied into the hydraulic chamber of the hydraulic bearing. This allows working loads in specific areas of the bearing to be reduced thus reducing wear and damages. This is important since as the blades are rotating, the portion of the blades under higher loads is varied so that more tensions are generated on a particular portion of the bearing. When a blade is in a horizontal position the bearing is not subjected to the same loads that when they are in a vertical position. Since these positions are predictable, the pressure of the fluid supplied by the injectors is varied depending on at least loads on the first or the second element according to said blade positions. In general, the fluid pressure inside the chamber can be controlled depending on at least one of the parameters relating to weight of the rotor elements, wind loads, blade azimuth position and blade pitch angle, etc. By increasing the pressure of the fluid supplied by the injectors in those regions subjected to higher loads a better load compensation can be achieved avoiding the bearing races to contact each other.

In some embodiments of the present rotating system, a single film-like chamber is formed between the first and second elements. This allows their relative rotation to be facilitated. In advantageous embodiments of the rotating system, the injectors may be provided distributed along the entire perimeter of the first and second elements.

The controller may be adapted for controlling at least one hydraulic pump associated with at least one of the injectors. However, each of the injectors themselves could be adapted for adjusting the pressure of the fluid injected into the chambers.

A wind turbine is also disclosed comprising the above angular positioning system. The angular positioning system in the present wind turbine serves the purpose of driving in rotation first and second mutually rotatable elements in the wind turbine.

In some embodiments, the angular positioning system may be at least part of the wind turbine pitch mechanism. In this case, the first element is the wind turbine rotor hub or it is associated therewith while the second element is the wind turbine rotor blade or it is associated therewith.

In some other embodiments, the angular positioning system may be at least part of the wind turbine yaw mechanism. In this case, the first element is the wind turbine tower or it is associated therewith, and the second element is the wind turbine nacelle or it is associated therewith.

The present wind turbine may comprise a number of angular positioning systems having a number of driving devices arranged at different planes. The present wind turbine may comprise a number of angular positioning systems having a number of bearings arranged at different planes. In specific embodiments, the angular positioning system in the present wind turbine may further include a bearing arrangement corresponding to or being part of a pitch mechanism and/or a yaw mechanism in the wind turbine. A suitable sealing device may be also provided with the purpose of preventing leaks of hydraulic fluid in the angular positioning system. The sealing device would be preferably associated with the hub, or in general to the one of the elements which is stationary.

According to what it has been explained above, the present angular positioning system is a dynamic system in which variable resisting loads are generated in order to compensate for the variable working loads. This is applicable for both the pitch drive and the pitch bearing in this angular positioning system.

With the above configuration, the problem of the axial displacement of the blades resulting from their changing position when in use allows it to be at least partially reduced. The provision of a number of injectors controlled separately by the controller (applicable both to pitch drive and pitch bearing) allows several, different points of pressure to applied in a controlled manner to different portions of the angular positioning system.

The present angular positioning acts is capable of combining the functions of both a pitch drive that contribute with distributed azimuthal, radial, and axial loads around the interface between blade and hub and a pitch bearing carrying out a smart hydraulic pressure distribution for compensating radial and axial loads along the interface between blade and hub.

Additional objects, advantages and features of embodiments will become apparent to those skilled in the art upon examination of the description, or may be learned by practice of the present disclosure.

### BRIEF DESCRIPTION OF THE DRAWINGS

Particular embodiments of the present angular positioning system will be described in the following by way of non-limiting examples.

This description is given with reference to the appended drawings, in which:

FIGS. 1-3 are schematic plan views of one embodiment of the present angular positioning system being part of a wind turbine pitch mechanism in which several relative angular positions of the first and the second elements are shown;

FIG. 1a diagrammatically shows one example of a hydraulic chamber with the protruding portion of the second element (a blade portion of a wind turbine pitch mechanism) dividing the hydraulic chamber into two hydraulic sub-chambers;

FIGS. 4-6 are schematic partial perspective views corresponding to the embodiment in FIGS. 1-3; and

FIGS. 7-8 are partial perspective views of the embodiment of the angular positioning system shown in FIGS. 1-6.

### DETAILED DESCRIPTION OF EMBODIMENTS

In these figures, one embodiment of an angular positioning system that is part of a wind turbine pitch mechanism is shown. This however could be applied to other rotating mechanism in a wind turbine such as a wind turbine yaw mechanism.

Like reference numerals refer to like parts throughout the description of several views of the drawings.

Pitch Drive

According to the figures, a wind turbine pitch mechanism 100 is schematically shown. The pitch mechanism 100 comprises first and second mutually rotatable elements 200, 300. In this particular embodiment the first element correspond to a wind turbine rotor hub 200, or a portion thereof, and the second element correspond to the wind turbine rotor blade 300 or a portion thereof such as a metallic blade extension or adapter.

As illustrated, both elements 200, 300 are substantially circular in cross-section. The wind turbine rotor blade 300 is arranged inside the wind turbine rotor hub 200 so the latter surrounds the former allowing relative rotation between them.

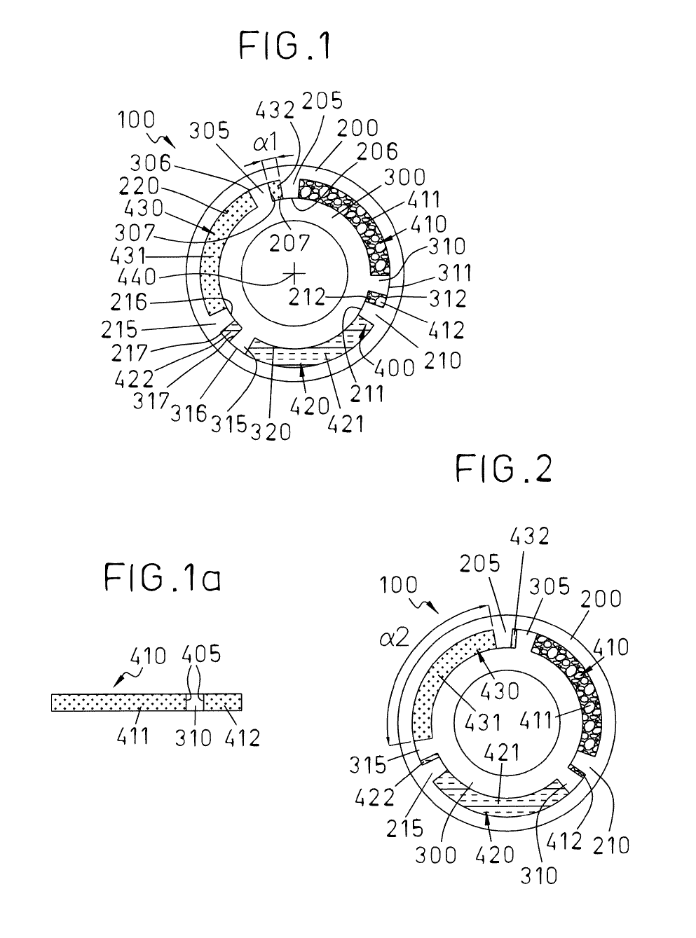

The pitch mechanism 100 shown in the FIGS. 1-8 comprises a driving device 400 capable of driving the rotor hub 200 and the rotor blade 300 in rotation. In the embodiment shown in the figures, the driving device 400 comprises a set of three hydraulic chambers 410, 420, 430. Each of these hydraulic chambers 410, 420, 430 are defined by respective protruding portions 205, 210, 215 of the rotor hub 200 and protruding portions 305, 310, 315 of the rotor blade 300.

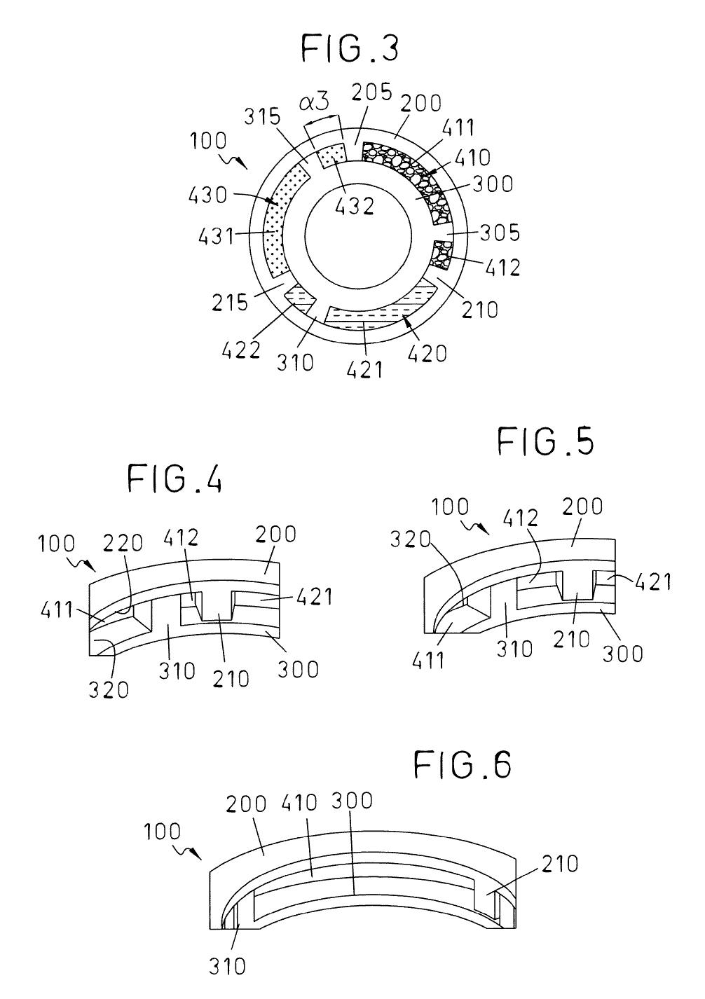

A particular example of the hydraulic chambers 410, 420, 430 will be now described in connection with FIG. 1 only. For the sake of clarity, FIGS. 2 and 3 show the structure but not all the reference numerals.

As shown in FIG. 1, the protruding portions 205, 210, 215 extend radially from the hub 200 and the protruding portions 305, 310, 315 extend radially from the blade 300. The protruding portions 305, 310, 315 of the blade 300 extend radially outwards, that is, to the hub 200. The protruding portions 205, 210, 215 of the hub 200 extend radially inwards, that is, to the blade 300. End walls 306, 311, 316 of the protruding portions 305, 310, 315 of the blade 300 are arranged in contact with the inner wall 220 of the hub 200. Likewise, end walls 206, 211, 216 of the protruding portions 205, 210, 215 of the hub 200 are arranged in contact with the outer wall 320 of the blade 300.

Referring now to FIGS. 1-8, hydraulic chambers 410, 420, 430 are provided. The hydraulic chambers 410, 420, 430 are each defined by the space between two mutually spaced apart portions 205-210, 210-215, 215-205 of the hub 200. Specifically, a first hydraulic chamber 410 is defined by the space between adjacent protruding portions 205-210 of the hub 200; a second hydraulic chamber 420 is defined by the space between adjacent protruding portions 210-215 of the hub 200; and a third hydraulic chamber 430 is defined by the space between adjacent protruding portions 215-205 of the hub 200.

As shown in FIGS. 1-3 of the drawings, inside each hydraulic chamber 410, 420, 430 a respective protruding portion 305, 310, 315 of the blade 300 is provided. As the blade 300 rotates relative to the hub 200, the respective protruding portion 305, 310, 315 moves inside the corresponding hydraulic chamber 410, 420, 430. The provision of a protruding portion 305, 310, 315 inside a hydraulic chamber 410, 420, 430 forms variable volume sub-chambers 411, 412, 421, 422, 431, 432, respectively. More specifically, inside the first hydraulic chamber 410, formed by the adjacent protruding portions 205, 210 of the hub 200, a first protruding portion 305 of the blade 300 is movably provided therein defining two corresponding variable volume sub-chambers 411, 412. Likewise, inside the second hydraulic chamber 420, formed by the adjacent protruding portions 210, 215 of the hub, a second protruding portion 310 of the blade 300 is movably provided therein defining two corresponding variable volume sub-chambers 421, 422. Finally, inside the third hydraulic chamber 430, formed by the adjacent protruding portions 215, 205 of the hub, a third protruding portion 315 of the blade 300 is movably provided therein defining two corresponding variable volume sub-chambers 431, 432.

According to the above configuration, the volume of each hydraulic chamber 410, 420, 430 is variable according to the relative position of the rotor hub 200 and the rotor blade 300 and consequently their corresponding protrusions 205, 210, 215 and 305, 310, 315. The relative position of the rotor hub 200 and the rotor blade 300 is defined by an angular displacement α.

Referring to FIG. 1, the angular displacement α is measured in a plane of rotation parallel to the figures, or substantially perpendicular to the axis of rotation 440 of the rotor hub 200 and the rotor blade 300. The angular displacement α corresponds to the angular distance between adjacent portions 205, 210, 215 and 305, 310, 315 of the hub 200 and the blade 300, respectively, that is, angular distances 205-305, 210-310, 215-315. More specifically the angle α is defined as the angular distance between one side surface 207, 212, 217 of the portions 205, 210, 215 of the rotor hub 200 and the corresponding side surface 307, 312, 317 of the portions 305, 310, 315 of the rotor blade 300 facing said hub side surfaces 207, 212, 217. This angle α may take values of, for example, α₁=5 degrees (FIGS. 1 and 4), α₃=15 degrees (FIGS. 2 and 5) or even α₂=90 degrees (FIGS. 3 and 6).

Depending on the relative angular displacement α of the rotor hub 200 and the rotor blade 300 the hydraulic chambers 410, 420, 430, 411, 421, 431 and therefore the corresponding sub-chambers 411, 412, 421, 422, 431, 432 will have a greater or smaller volume.

The driving device 400 of the angular positioning system 100 further comprises a pump including a number of injectors 405. Injectors 405 are suitable for injecting hydraulic fluid such as oil into the hydraulic chambers 410, 420, 430 of the pitch mechanism 100. The pressure at the chambers 410, 420, 430 gives rise a relative torque between blade 300 and hub 300.

Injectors 405 connect hydraulic sub-chambers 411-412 of chamber 410 in fluid communication to each other. Further injectors 405 connect hydraulic sub-chambers 421-422 of chamber 420 in fluid communication to each other and additional injectors 405 connect hydraulic sub-chambers 431-432 of chamber 430 in fluid communication to each other. Injectors 450 may be independent or common injectors 450. In general hydraulic chambers are connected to each other such that hydraulic fluid is pumped from one hydraulic sub-chamber to another hydraulic sub-chamber.

Injection of hydraulic fluid into the hydraulic chambers 410, 420, 430 through injectors 405 causes some sub-chambers to expand and some sub-chambers to contract (hydraulic fluid is compressed). This involves variations in the value of the angular displacement (a). By means of a selective injection of the hydraulic fluid into the sub-chambers 411, 412, 421, 422, 431, 432 the direction of rotation of the blade 300 can be varied. This results in pitching of the blade 300 relative to the hub 200, that is, rotation of the blade 300 around its longitudinal axis (i.e. the axis extending from the blade root to the blade tip). This allows the angle of attack of the blades 300 to be adjusted precisely according to the wind speed in order to efficiently control the rotational speed of the hub 200.

The driving device 400 of the pitch drive 100 further comprises a controller (not shown) for controlling the pumps. The controller comprises a control unit that allows controlling the fluid that is injected into the hydraulic chambers 410, 420, 430 for accurately controlling the rotation of the hub 200 and the blade 300.

The present angular positioning system 100 further comprises at least one pitch bearing arrangement which will be disclosed below.

Pitch Bearing

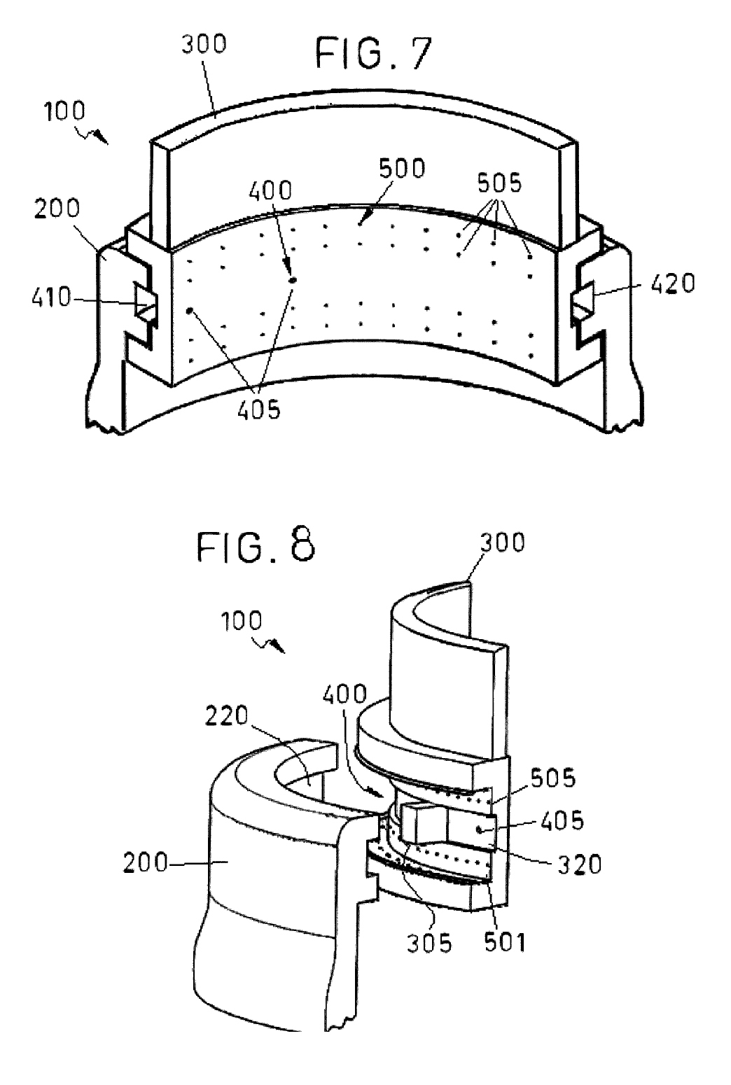

The pitch bearing arrangement is indicated at 500 in FIGS. 7 and 8 of the drawings. The pitch bearing 500 in the embodiment shown is a hydraulic bearing comprising a single hydraulic film-like chamber 501. This hydraulic chamber 501 is formed between the first and the second elements, that is, between an inner wall 220 of the hub 200 and an outer wall 320 of the blade 300 of the wind turbine. This allows the rotation of the blade 300 relative to the hub 200 to be facilitated when driven. Note that the terms hub 200 and blade 300 may refer to portions or parts thereof.

As in the driving device 400 of the above disclosed pitch drive 100, the present pitch bearing 500 includes a number of injectors 505. The injectors 505 are distributed around the length of one portion of the blade 300, such as a metallic blade extension or adapter, as shown in FIGS. 7 and 8. The plurality of injectors 505 are adapted for injecting hydraulic fluid such as oil into the hydraulic chamber 501 defined between the hub 200 and the blade 300.

A controller is further provided for separately controlling the pressure of the hydraulic fluid injected by the injectors 505. The pressure of the hydraulic fluid supplied by the injectors 505 can be varied through the controller (not shown) depending on at least loads on the rotor hub 200 and the rotor blade 300 of the wind turbine. The injectors 505 are separately controlled in order to advantageously compensate for the action of the gravity in the blade changing angular position while allowing total working loads on the bearing arrangement 500 to be reduced in specific areas thereof. In this respect, the pressure of the fluid supplied by the injectors 505 can be increased in those regions subjected to higher loads. Good load compensation is thus achieved avoiding the elements 200, 300 to contact each other.

The disclosed angular positioning system 100 can be advantageously used in a wind turbine for rotation of the blades 300 relative to the hub 200 in a pitch mechanism. However, the disclosed angular positioning system 100 can be also advantageously used in a wind turbine for rotation of the nacelle relative to the tower a yaw mechanism. In any case, a number of angular positioning systems 100 having a number of driving devices 400 and/or hydraulic bearings 500 may be provided arranged at different planes, preferably at substantially mutually parallel planes.

The present angular positioning system 100 is capable of at least reducing net radial loads on the hydraulic bearing 500 avoiding the use of stiffening solutions which are required present in prior art pitch mechanisms. The present angular positioning system 100 is also capable of ensuring robustness over deformations of very flexible blades 300 and hubs 200 in a wind turbine.

Although only a number of particular embodiments and examples of the present angular positioning system have been disclosed herein, it will be understood by those skilled in the art that other alternative embodiments and/or uses and obvious modifications as well as equivalents thereof are possible. For example, the present angular positioning system is applicable both to onshore and offshore wind turbines. On the other hand, the present angular positioning system has been disclosed and shown with the blade fitted around the hub such that a portion of the hub is rotatably arranged outside a portion of the blade. However, in alternative embodiments, the angular positioning system could be for a rotating system such as a pitch drive where a portion of the hub would be rotatably arranged inside a portion of the blade.

This disclosure covers all possible combinations of the particular embodiments described herein. Reference signs related to drawings and placed in parentheses in a claim are solely for attempting to increase the intelligibility of the claim, and shall not be construed as limiting the scope. Thus, the scope of the present disclosure should not be limited by particular embodiments, but should be determined only by a fair reading of the claims that follow.

1. An angular positioning system for a wind turbine, the angular positioning system comprising:
first and second mutually rotatable elements and a driving device for driving at least one of the elements in rotation, the driving device comprising at least one hydraulic chamber, wherein the volume of the hydraulic chamber is defined by a relative position of the first and second elements in a plane of rotation;
the driving device further comprising a pump for filling the hydraulic chamber with fluid in order to cause an expansion of the chamber such that the first and the second elements are rotated relative to each other, and a controller for controlling the pump, thereby controlling the rotation of the first and second elements.

2. The angular positioning system of claim 1, wherein a volume of the hydraulic chamber is defined by at least a first portion of the first element and a second portion of the second element.

3. The angular positioning system of claim 1, wherein the hydraulic chamber is defined by a space between at least two mutually spaced apart portions of one of the first and second elements and a respective protruding portion of the other of the first and second elements movably provided inside the hydraulic chamber to thereby define variable volume sub-chambers.

4. The angular positioning system of claim 1, wherein a number of hydraulic chambers are provided and the pump is arranged connecting two adjacent hydraulic chambers to each other such that fluid is pumped from one hydraulic chamber to another.

5. The angular positioning system of claim 1, wherein the driving device comprises a number of sets of chambers covering different angles (α) of the first and second elements, each set of chambers having a pump associated therewith.

6. The angular positioning system of claim 5, wherein at least one chamber of the set of chambers covers an angle α arranging from 0 to 90°.

7. The angular positioning system of claim 1, wherein the system further includes at least one bearing arrangement comprising rolling elements.

8. The angular positioning system of claim 1, wherein the system further includes at least one bearing arrangement comprising a hydraulic mechanism including at least one hydraulic chamber formed between the first and second elements, one or several fluid injectors and a controller for controlling the pressure of the fluid injected by the injectors, wherein the pressure is varied in response to loads on the first or the second elements.

9. The angular positioning system of claim 8, wherein the system comprises a single film-like chamber formed between the first and second elements for facilitating their relative rotation, and a number of injectors controlled separately by the controller, thereby allowing different points of pressure to be applied in different portions of the hydraulic bearing arrangement.

10. The angular positioning system of claim 8, wherein a number of injectors are distributed along an entire perimeter of the first and second elements.

11. The angular positioning system of claim 8, wherein the controller is adapted for controlling at least one hydraulic pump associated with at least one of the injectors.

12. The angular positioning system of claim 8, wherein the controller is adapted for independently controlling a number of hydraulic pumps associated with corresponding injectors.

13. The angular positioning system of claim 8, wherein fluid pressure inside the chamber is controlled by a control unit that varies the fluid pressure based on at least one of the parameters relating to weight of at least one of the first and second elements, wind loads, blade azimuth position and blade pitch angle.

14. The angular positioning system of claim 8, wherein the first and second elements are counter shaped such that one can be fitted into the other in a way that they remain spaced apart in radial and axial directions when in use.

15. A wind turbine comprising the angular positioning system of claim 1 for driving at least one of a first and second mutually rotatable elements of the wind turbine in rotation.

16. The wind turbine of claim 15, wherein the angular positioning system is at least part of a wind turbine pitch mechanism, the first element being a rotor hub or being associated therewith, and the second element being a rotor blade or being associated therewith.

17. The wind turbine of claim 15, wherein the angular positioning system is at least part of a wind turbine yaw mechanism, the first element being a wind turbine tower or being associated therewith, and the second element being a wind turbine nacelle or being associated therewith.

18. The wind turbine of claim 15, wherein the turbine comprises a number of angular positioning systems having a number of driving devices provided in different planes.

19. The wind turbine of claim 15, wherein the turbine comprises a number of angular positioning systems having a number of bearing arrangements provided in different planes.

20. The wind turbine of claim 15, wherein the turbine further comprises a sealing means device for preventing leaks of a hydraulic fluid.

21. The wind turbine of claim 15, wherein the angular positioning system further includes a bearing arrangement corresponding to or being part of a pitch mechanism and/or a yaw mechanism in the wind turbine.
